(19) United States
(12) Patent Application Publication
(10) Pub. No.: US 2009/0130241 A1
(43) Pub. Date: May 21, 2009

(54) Metal Mold for Forming Wooden Piece

(75) Inventors: Tatsuya Suzuki, Tokyo (JP); Nobuo Kitayoshi, Tokyo (JP)

Correspondence Address: HOGAN & HARTSON L.L.P., 1999 AVENUE OF THE STARS, SUITE 1400, LOS ANGELES, CA, 90067, US

(73) Assignee: OLYMPUS CORPORATION, Tokyo (JP)

(21) Appl. No.: 12/355,516

(22) Filed: Jan. 16, 2009

Related U.S. Application Data
(63) Continuation of application No. PCT/JP2007/063786, filed on Jul. 11, 2007.

(30) Foreign Application Priority Data
Jul. 20, 2006 (JP) 2006-198578

(51) Int. Cl. B29C 43/36

(52) U.S. Cl. 425/112

(57) ABSTRACT

A metal mold for forming a wooden piece by applying a compressive force to the wooden piece includes a discharge passage for discharging air present between the wooden piece and the metal mold to outside at a time of forming of the wooden piece.

### CROSS-REFERENCE TO RELATED APPLICATIONS

This application is a continuation of PCT international application Ser. PCT/JP2007/063786 filed Jul. 11, 2007 which designates the United States, incorporated herein by reference, and which claims the benefit of priority from Japanese Patent Application No. 2006-198578, filed Jul. 20, 2006, incorporated herein by reference.

### BACKGROUND OF THE INVENTION

1. Field of the Invention

The present invention relates to a metal mold for forming a wooden piece by applying a compressive force to the wooden piece.

2. Description of the Related Art

In recent years, wood which is a natural material attracts attention. With a wide variety of grain patterns, wood products exhibit individual features depending on positions of the raw wood from which the particular wood products are cut out. In addition, surface flaws and discolorations caused by a long-term use create unique textures which tend to evoke warm and familiar feeling in the user. Thus, the wooden material attracts attention as a material for products of uniqueness and taste which cannot be found in products made of synthetic resin or light metals. Techniques for processing wooden materials are also developing dramatically.

According to one conventionally known technique for processing wooden piece, a wooden board is softened with water absorption and compressed; the compressed wooden board is cut along a direction substantially parallel with a direction of the compressive force, whereby a primary fixed product with a board-like shape is obtained; and the primary fixed product is deformed into a desired three-dimensional shape under heat and moisture (see, for example, Japanese Patent No. 3078452). Further, according to another conventional technique, a softened wooden board is compressed and temporarily fixed and left in a prepared mold until the wooden board recovers, so that a wooden product with a desired shape can be obtained (see, for example, Japanese Patent Application Laid-Open No. H11-77619). For the techniques as described above, thickness and compression rate of wooden materials are determined based on various aspects such as an individual difference, a kind, required strength after processing, and a purpose of use. In general, compression of the wooden piece is carried out on a wooden piece in a sufficiently softened state.

### SUMMARY OF THE INVENTION

A metal mold according to an aspect of the present invention is for forming a wooden piece by applying a compressive force to the wooden piece, and includes a discharge passage for discharging air between the wooden piece and the metal mold to outside upon formation of the wooden piece.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic view of a wooden piece which is molded in a metal mold for forming a wooden piece according to a first embodiment of the present invention;

FIG. 2 is a schematic view of a compression process of a wooden piece which is molded in the metal mold for forming a wooden piece according to the first embodiment of the present invention;

FIG. 3 shows a wooden piece at a start of compression in a compression process;

FIG. 4 shows the wooden piece deforming in the middle of the compression process;

FIG. 5 shows the wooden piece whose deformation has nearly finished in the compression process;

FIG. 6 is a perspective view of a structure of the wooden piece obtained after the compression process;

FIG. 7 is a perspective view of a structure of a cover member which is a wooden piece after a shaping process (first example);

FIG. 8 is a perspective view of a structure of a cover member which is a wooden piece after the shaping process (second example);

FIG. 9 is a perspective view of an external structure of a digital camera covered with the cover member shown in FIGS. 7 and 8;

FIG. 10 is a schematic view of a compression process of a wooden piece which is molded in a metal mold for forming a wooden piece according to a second embodiment of the present invention;

FIG. 11 is a view of a structure of the wooden piece after compression in the metal mold for forming a wooden piece according to the second embodiment of the present invention;

FIG. 12 is a schematic view of a compression process of a wooden piece which is molded in a metal mold for forming a wooden piece according to a third embodiment of the present invention;

FIG. 13 is a perspective view of a structure of a compressed wood product which is obtained through compression in the metal mold for forming a wooden piece according to the third embodiment of the present invention and to which a reinforcing member is attached; and

FIG. 14 is a sectional view taken along line B-B of FIG. 13.

### DETAILED DESCRIPTION OF THE PREFERRED EMBODIMENTS

Preferred embodiments of the present invention (hereinafter simply referred to as “embodiments”) will be described below with reference to the accompanying drawings. The drawings which are referred to hereinafter are merely schematic, and the dimension and scale of the same object may be different in each drawing.

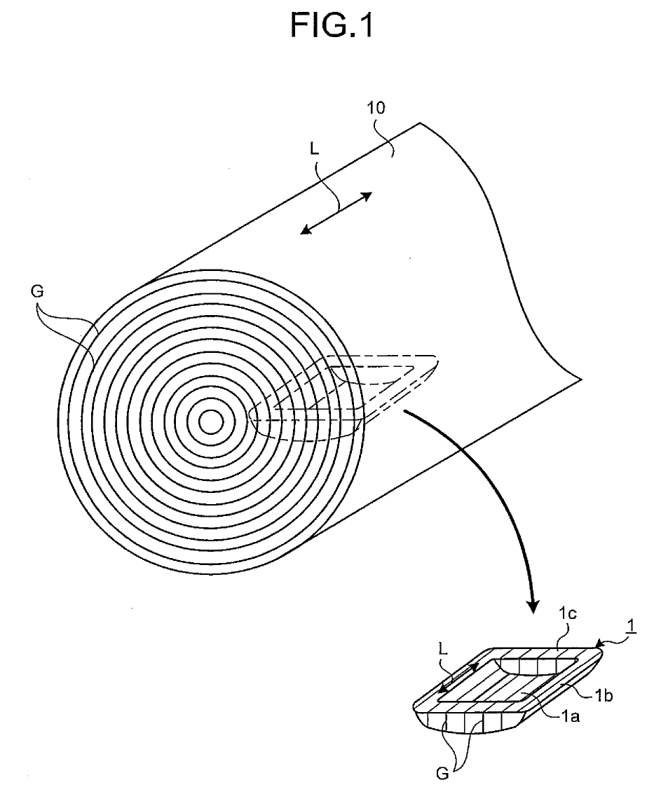

Before a wooden piece is subjected to compression in a metal mold for forming a wooden piece according to a first embodiment of the present invention, firstly, a wooden piece with a predetermined shape is cut out from a raw wood (cutting-out process). FIG. 1 schematically shows the cutting-out process. In the cutting-out process, a wooden piece 1 with a dish-like shape is cut out from an uncompressed raw wood 10 (having a grain pattern C) by cutting or the like. The wooden piece 1 includes a main plate portion 1a that has a substantially rectangular surface and is slightly curved, two side plate portions 1b which extend from two sides of the main plate portion 1a forming a predetermined angle with the main plate portion 1a, the two sides being substantially parallel with the lengthwise direction of the main plate portion 1a, and two side plate portions 1c which extend from two sides of the main plate portion 1a forming a predetermined angle with the main plate portion 1a, the two sides being substantially parallel with the breadthwise direction of the main plate portion 1a. End surfaces of the side plate portions 1b and 1c are connected to each other thus forming a closed round surface as a whole. The wooden piece 1 has a volume to which an amount to be decreased during a compression process is added in advance. Here, “dish-like shape” means a three-dimensional shape with a curved surface in general, such as bowl-like shape, shell-like shape, box-like shape, boat-like shape, and the like, and the shape shown in FIG. 1 is merely an example.

The kind of the raw wood 10 may be appropriately selected, for example, from various types of wood including Japanese cedar, hiba cedar, paulownia, Japanese cypress, pine, cherry, zelkova, ebony wood, palisander, bamboo, teak, mahogany, and rosewood depending on the purpose of use and the like of the processed wooden piece.

FIG. 1 shows the wooden piece 1 cut out from the raw wood 10 in such a manner that the lengthwise direction of the wooden piece 1 is substantially parallel with a fiber direction L of the wooden piece 1, and that the surface of the main plate portion 1a shows a straight-grain pattern. Alternatively, the wooden piece 1 may be cut out so that the lengthwise direction of the wooden piece 1 is substantially parallel with the fiber direction L of the wooden piece 1, though the surface of the main plate portion 1a shows a flat-grain pattern, or an intermediate grain pattern of the flat-grain and the straight-grain. Still alternatively, the wooden piece 1 may be cut out so that the lengthwise direction of the wooden piece 1 is substantially perpendicular to the fiber direction L of the wooden piece 1, and so that the surface of the main plate portion 1a shows an end-grain pattern. The required conditions such as strength and appearance determine a manner of cutting-out of the wooden piece in the cutting-out process. Therefore, the grain pattern G is not particularly shown in the drawings referred to hereinafter.

In the first embodiment of the present invention, a hole is formed after the cutting-out process. The hole penetrates a substantially central portion of the main plate portion 1a of the wooden piece 1 in a thickness direction (hole-forming process). A position and a function of the hole formed in the hole-forming process will be described later in detail.

Thereafter, the wooden piece 1 is left in a water vapor atmosphere of a temperature and pressure higher than those of an atmospheric air for a predetermined time period, whereby the wooden piece 1 is sufficiently softened through excessive absorption of moisture (softening process). Here, the high temperature is approximately 100 to 230° C., and preferably approximately 180 to 230° C., and more preferably approximately 180 to 200° C., and the high pressure is approximately 0.1 to 3.0 MPa (megapascal), preferably approximately 0.45 to 2.5 MPa, and more preferably approximately 1.0 to 1.6 MPa.

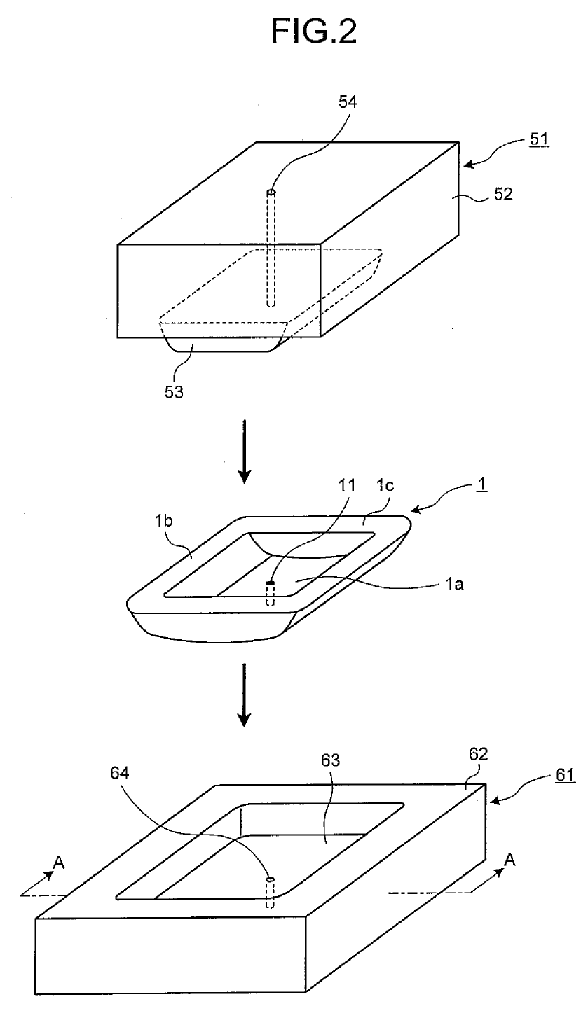

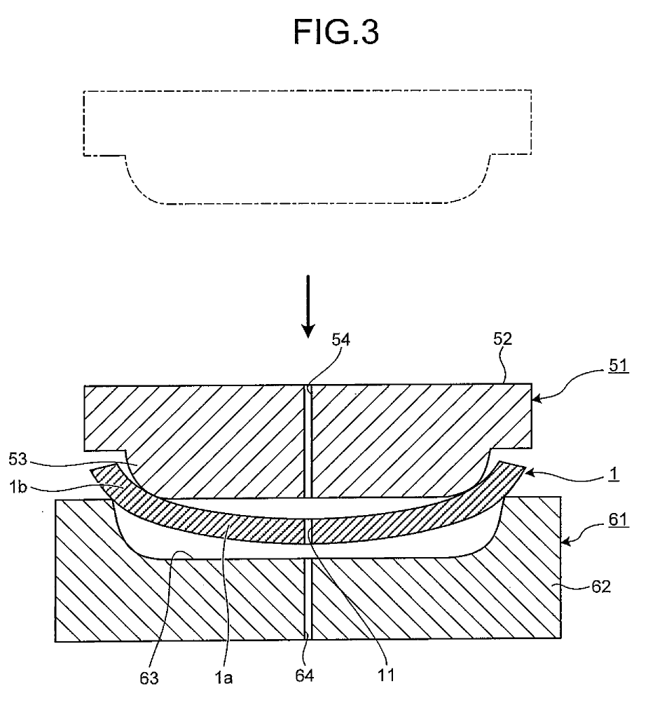

After the sufficient softening in the softening process, the wooden piece 1 is compressed (compression process). FIG. 2 schematically shows the compression process and a structure of the metal mold for forming a wooden piece according to the first embodiment. FIG. 3 shows the wooden piece 1 to which a compressive force has started to be applied by the metal mold for forming a wooden piece according to the first embodiment, in a sectional view along line A-A of FIG. 2. As shown in FIGS. 2 and 3, the metal mold for forming a wooden piece according to the first embodiment includes a pair of metal molds 51 and 61. Structures of the metal molds 51 and 61 will be described hereinbelow.

The metal mold 51 which applies a compressive force to the wooden piece 1 from above in the compression process is a core metal mold including a rectangular main body 52 and a protrusion 53 which bulges on the main body 52 and can be brought into contact with a curved surface (inner side surface) corresponding to a depressed portion of the wooden piece 1. The metal mold 51 is provided with a discharge hole 54 which penetrates through the main body 52 by extending upward in FIG. 3 from a substantially central portion of a bottom surface (contact surface) of the protrusion 53. The discharge hole 54 serves as a discharge passage which discharges water vapor (air) present between the wooden piece 1 and the metal mold 51 at the time of compression to the outside. As shown in FIG. 3, a curvature radius of the surface of the depressed portion is larger than a curvature radius of the portion extending and curving from the bottom surface of the protrusion 53 to the bottom surface of the main body 52 over an entire range.

On the other hand, the metal mold 61 which applies a compressive force to the wooden piece 1 from below in the compression process is a cavity metal mold including a rectangular main body 62 and a depression 63 which is formed on one surface of the main body 62 and can be brought into contact with a surface (outer side surface) corresponding to a protruding portion of the wooden piece 1. The metal mold 61 is provided with a discharge hole 64 which penetrates through the main body 62 by extending downward in FIG. 3 from a substantially central portion of a bottom surface (contact surface) of the depression 63. The discharge hole 64 serves as a discharge passage which discharges water vapor (air) present between the wooden piece 1 and the metal mold 61 to the outside at the time of compression. The central axis of the discharge hole 64 coincides with the central axis of the discharge hole 54 of the upper metal mold 51. As shown in FIG. 3, a curvature radius of the surface of the protruding portion is larger than a curvature radius of a portion extending and curving from the surface of the depression 63 to an upper surface of the main body 62 in an entire range.

As far as the discharge holes 54 and 64 penetrate the main bodies 52 and 62, respectively, and are communicated with the outside, they do not need to be formed in a linear shape. It is preferable, however, that the central axis of the discharge hole 54 near an end opening in the protrusion 53 coincide with the central axis of the discharge hole 64 near an end opening in the depression 63.

In the compression process, at least one of the metal molds 51 and 61 is moved to the other of the metal molds 51 and 61 in the same water vapor atmosphere as employed in the softening process, so that the wooden piece 1 is sandwiched therebetween and receives a compressive force. Thus, the wooden piece 1 is molded into a predetermined three dimensional shape. In the first embodiment, the metal mold 51 is lowered down to the metal mold 61.

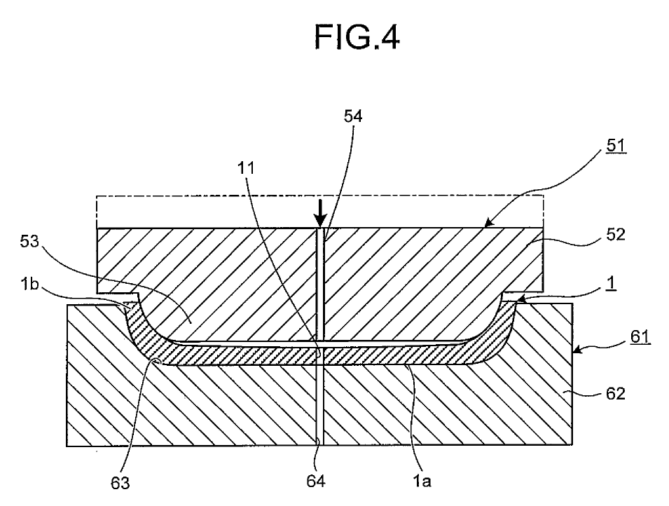

FIG. 4 shows the metal mold 51 lowered further down from the state shown in FIG. 3. During the process from the state shown in FIG. 3 to the state shown in FIG. 4, on the lower surface side of the wooden piece 1, a central portion of the main plate portion 1a first touches a central portion of the depression 63, and the main plate portion 1a gradually deforms while increasing a contact area with the depression 63. On the other hand, on the upper surface side of the wooden piece 1, a peripheral portion which is not in contact with the protrusion 53 gradually rises and deforms so as to approach the protrusion 53. Thus, the upper side surface of the wooden piece 1 gradually deforms while increasing the contact area with the protrusion 53 from the peripheral portion of the protrusion 53 to the central portion thereof.

As the metal mold 51 is lowered, a gap between the wooden piece 1 and the protrusion 53 and a gap between the wooden piece 1 and the depression 63 gradually decrease. During this process, water vapor corresponding to a decreased amount of volume of the gaps can escape to the outside through the discharge holes 54 and 64. Therefore, even when the softened wooden piece 1 adheres to the metal molds 51 and 61, no trouble is caused during the compression since a discharge passage of the water vapor is secured.

In the first embodiment, a hole 11 is formed in the wooden piece 1 in the hole-forming process (see FIG. 2). The hole 11 is formed at such a position that the hole is coaxially communicated with the discharge hole 64 in a state shown in FIG. 4, in other words, when the central portion of the main plate portion 1a of the wooden piece 1 deforms to contact the depression 63 of the metal mold 61 (see FIG. 4).

As described above, in the first embodiment, the metal molds 51, 61, and the wooden piece 1 are configured so that the hole 11 and the discharge hole 54 of the metal mold 51 are coaxially communicated with the discharge hole 64 below. Therefore, the water vapor (including resin component) present in the gap between the wooden piece 1 and the metal mold 61 can be discharged through the discharge holes 64 and 54. As a result, following effects can be realized. While the wooden piece 1 transits from the state shown in FIG. 3 to the state shown in FIG. 4, a part of resin component in the wooden piece 1 evaporates with the water vapor. In the state shown in FIG. 4, since the discharge hole 64 has an end opening at a substantially central portion of the surface of the depression 63, the resin component adhered to the surface of the depression 63 tends to gather and might clog the discharge hole 64 depending on the viscosity of the resin component and the diameter of the discharge hole 64, for example. In the first embodiment, however, the water vapor present in the gap between the wooden piece 1 and the metal mold 61 can be also discharged through the hole 11 and the discharge hole 54 to the outside. Therefore, the water vapor does not concentrate on the discharge hole 64, whereby the discharge hole 64 is less likely to be clogged. Further, even when the discharge hole 64 is clogged, the air including the resin component can be discharged through the discharge hole 54.

Further, depending on the shape of the wooden piece 1 and/or the shape of the compressed wooden piece 1, the hole 11 may not be formed, or the discharge hole may be formed on one of the metal molds. Diameters and sectional shapes of the hole 11, the discharge holes 54 and 64 can be determined appropriately depending on the shape of the wooden piece 1 and/or the compressed wooden piece 1.

The compression process will be described next. When the metal mold 51 is lowered further from the state shown in FIG. 4 toward the metal mold 61, the upper surface of the wooden piece 1 is brought into close contact with the surface of the protrusion 53 of the metal mold 51, while the lower surface of the wooden piece 1 is brought into close contact with the surface of the depression 63 of the metal mold 61. FIG. 5 shows the wooden piece 1 in this close-contact state after the deformation of the wooden piece 1 in the compression process is nearly finished. As shown in FIG. 5, the wooden piece 1 is eventually deformed into a three-dimensional shape corresponding to a gap between the metal molds 51 and 61 in the compression process.

After the wooden piece 1 is compressed for a predetermined time period (one to dozens of minutes, or more preferably approximately 5 to 10 minutes) in the state shown in FIG. 5, the water vapor atmosphere is removed, to dry the wooden piece 1. Then, the metal molds 51 and 61 are separated from each other so that the wooden piece 1 is released from compression. Thus, the shape of the wooden piece 1 is fixed. Hereafter, the wooden piece whose shape is fixed through the compression process is referred to as “wooden piece 2”.

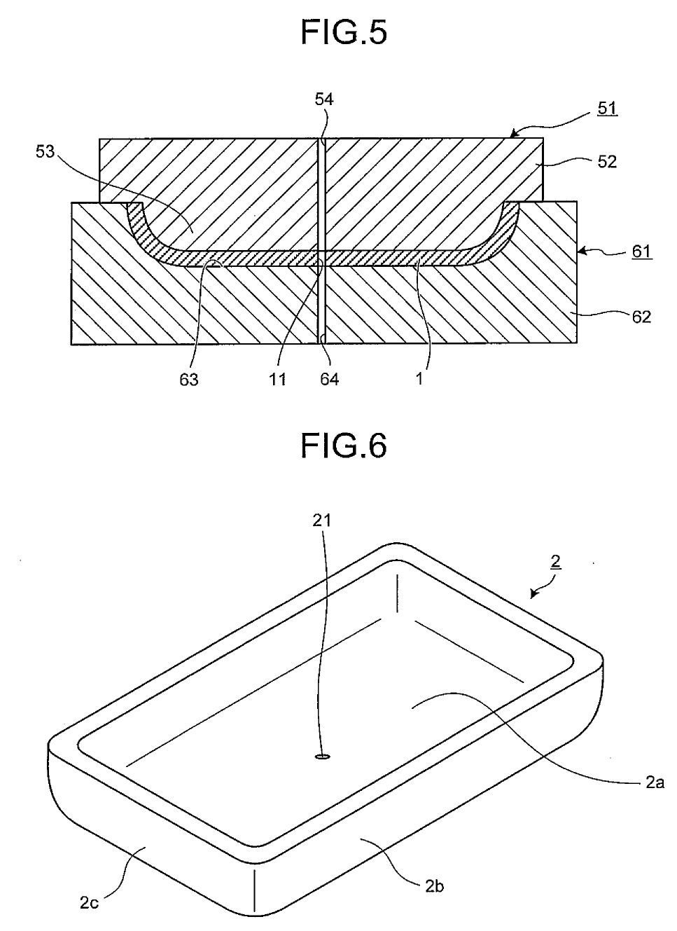

FIG. 6 is a perspective view of a structure of the wooden piece 2. The wooden piece 2 shown in FIG. 6 has a main plate portion 2a, and side plate portions 2b and 2c corresponding respectively to the main plate portion 1a, and the side plate portions 2b and 2c of the wooden piece 1. A hole 21 corresponding to the hole 11 is provided in a substantially central portion of the main plate portion 2a. Though the hole 21 corresponds to the hole 11 of the wooden piece 1 the hole 21 may have a different diameter from the diameter of the hole 11 due to compression. Further, a surrounding portion of the hole 21 may have a different thickness from the remaining portions, or a surface of the surrounding portion may be deteriorated due to compression.

The thickness of the wooden piece 2 after the compression is preferably approximately 30 to 50% of the thickness of the wooden piece 1 before the compression. In other words, compression rate of the wooden piece 1 in the compression process (i.e., ratio ΔR/R of the decreased thickness ΔR of the wooden piece 1 due to the compression to the thickness R of the wooden piece before the compression) is preferably approximately 0.50 to 0.70.

In the compression process described above, when at least one of the metal molds 51 and 61 is moved to the other mold, an appropriate driving unit may be employed to electrically move the metal mold 51 and/or the metal mold 61, so as to adjust the compressive force applied to the wooden piece 1. Alternatively, the metal molds 51 and 61 may be connected with each other by a screw, so that the vertical movement of the metal mold 51 relative to the metal mold 61 can be realized with manual or automatic screwing.

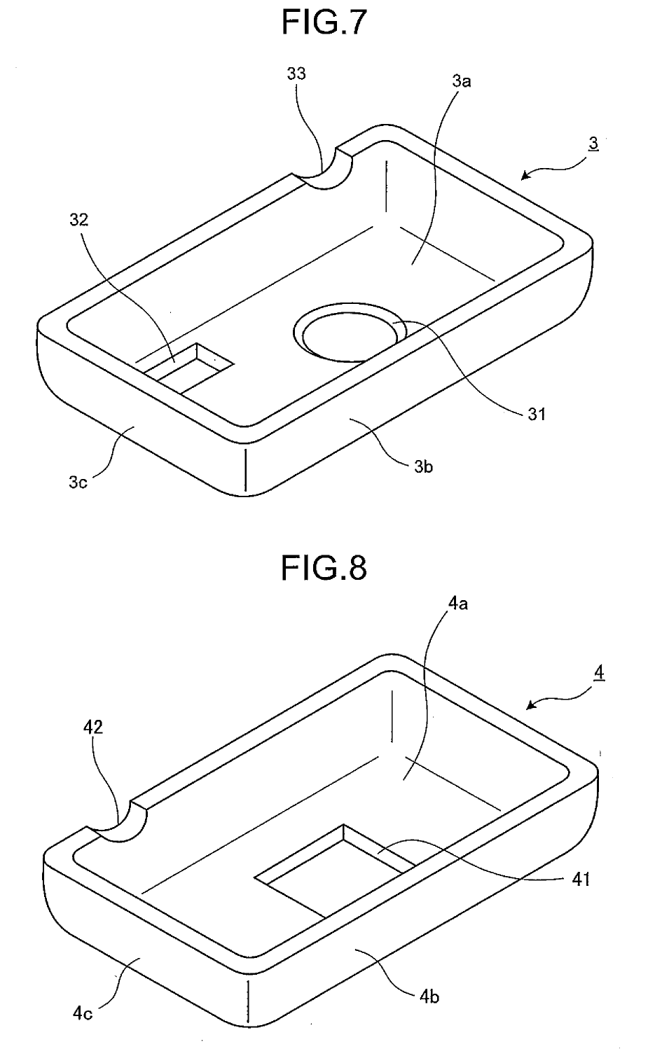

After the compression process described above, the wooden piece 2 is shaped into a desired three-dimensional shape through cutting, drilling, or the like (shaping process). FIGS. 7 and 8 are perspective views of structures of compressed wood products formed through shaping of the wooden piece 2. The compressed wood products shown in FIGS. 7 and 8 are cover members that are part of a jacket member of a digital camera. A cover member 3 shown in FIG. 7 includes a main plate portion 3a, two side plate portions 3b, and two sides plate portions 3c corresponding respectively to the main plate portion 2a, two side plate portions 2b, and two side plate portions 2c of the wooden piece 2. In the main plate portion 3a, a circular opening 31 which exposes an image-pick up unit including an imaging lens of the digital camera and a rectangular opening 32 which exposes a photoflash of the digital camera are formed. Further, a semi-circular cutout 33 is formed on the side plate portion 3b.

On the other hand, a cover member 4 shown in FIG. 8 includes a main plate portion 4a, two side plate portions 4b, and two sides plate portions 4c corresponding respectively to the main plate portion 2a, two side plate portions 2b, and two side plate portions 2c of the wooden piece 2. In the main plate portion 4a, a rectangular opening 41 is formed to expose a display unit of the digital camera realized with a screen such as a liquid display, a plasma display, and an organic EL display. Further, a semi-circular cutout 42 is formed on the side plate portion 4b. The cutout 42 is joined with the cutout 33 of the cover member 3 to form an opening to expose the shutter button of the digital camera.

The hole 21 of the wooden piece 2, which is made into the cover members 3 and 4, is formed in such a position that the hole 21 is removed during the formation of the openings 31 and 41 in the shaping process. Therefore, even when a surrounding portion of the hole 21 is deteriorated due to compression, the deteriorated portion is removed, whereby the appearance of the product is not degraded. Thus, when the hole 11 is formed in the wooden piece 1, the hole 11 is preferably in such a position that the hole 21 of the wooden piece 2 after the compression comes to a position which is removed at a finishing stage of the compressed wood product, or to a position covered by other member and not seen from the outside.

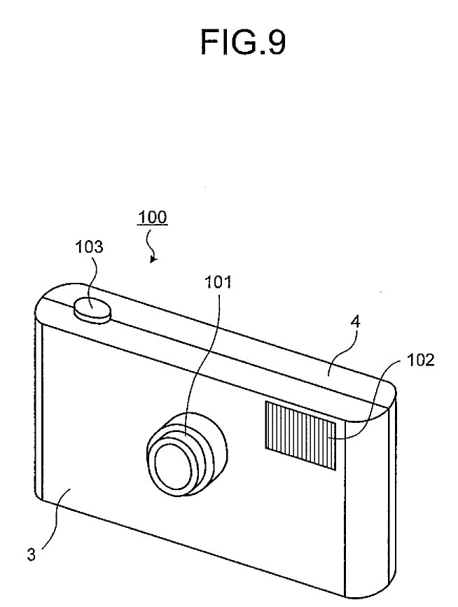

FIG. 9 is a perspective view of an external structure of a digital camera covered by the cover members 3 and 4. A digital camera 100 shown in FIG. 9 includes an image pick-up unit 101 having an imaging lens (exposed from the opening 31), a photoflash 102 (exposed from the opening 32), and a shutter button 103 (exposed from the opening formed by the cutouts 33 and 42). Further, though not shown, a display unit is exposed from the opening 41 of the cover member 4. Inside the digital camera 100, various electronic components and optical components (not shown) are housed to realize functions of the digital camera 100. Housed components are, for example, a control circuit that performs drive control related to image pick-up process or other various operations, a solid-state image sensing device such as a charge coupled device (CCD) or a complementary metal-oxide semiconductor (CMOS), an audio input/output device such as microphone or speaker, and a drive circuit that drives each functioning component under control by the control circuit.

An electronic device to which the jacket member obtained through the shaping of the wooden piece 2 can be applied includes, other than the digital camera 100, various portable communication terminals such as cellular phone, personal handy-phone system (PHS), and personal data assistant (PDA), a portable audio system, an IC recorder, a portable television, a portable radio, a remote control of various consumer electronics, and a digital video. Preferably, when applied to these small portable electronic devices, the jacket member is approximately 1.6 to 2.0 mm in thickness.

The metal mold for forming a wooden piece according to the first embodiment of the present invention is provided with the discharge hole (i.e., discharge passage) which penetrates the main body portion from the contact surface which is brought into contact with the wooden piece to be molded and is communicated with the outside, whereby the compression of a softened wooden piece can be performed without trouble.

Further, according to the first embodiment, the discharge hole is formed in each metal mold of the pair of metal molds so that the central axes of the discharge holes coincide with each other, and further, the hole which communicates with the discharge holes mentioned above during the application of the compressive force is formed in a wooden piece to be molded, whereby plural discharge passages are secured to discharge the waver vapor present in the gap between the wooden piece and the metal mold. Thus, the water vapor present between the metal mold and the wooden piece can be more securely discharged to the outside at the time of compression.

Still further, according to the first embodiment, the hole formed in the wooden piece is in a portion which is removed during the shaping process after the compression process, for example, and not utilized. Therefore, even when the surrounding portion of the hole is deteriorated due to the compression, the hole does not leave any marks in a finished product after the shaping. Thus, according to the first embodiment, the appearance of the wooden piece in a final product stage is not degraded.

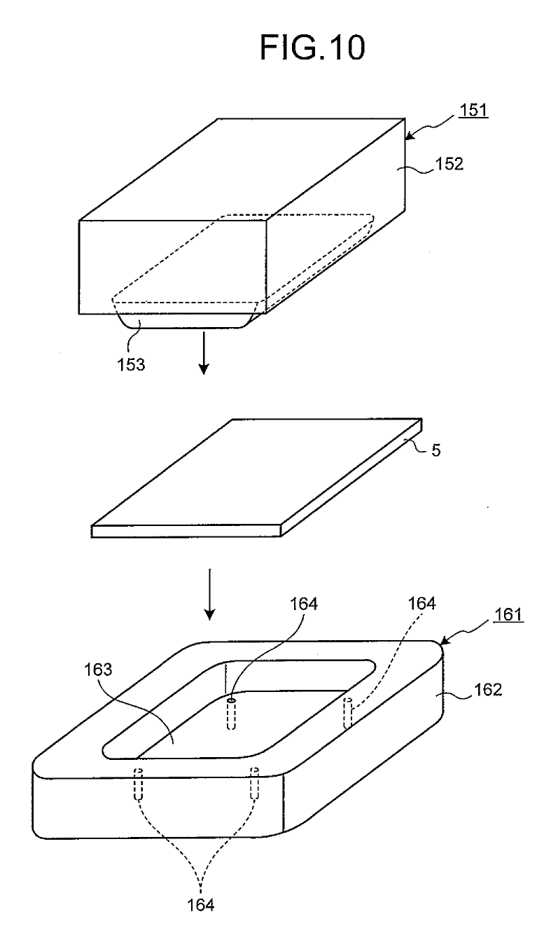

FIG. 10 shows a structure of a metal mold for forming a wooden piece according to a second embodiment of the present invention and schematically shows a compression process of a wooden piece performed with the metal mold for forming a wooden piece. Metal molds 151 and 161, which are the metal mold for forming a wooden piece according to the second embodiment, are employed when sandwiching a board-like wooden piece 5 cut out from raw wood and performing a compression to form a dish-like member. Conditions for softening the wooden piece 5 before the compression process and conditions for applying the compressive force in the compression process are the same as those in the first embodiment.

The metal mold 151, which applies a compressive force to the wooden piece 5 from above at the time of compression, is a core metal mold including a rectangular main body 152, and a protrusion 153 which bulges downward from the main body 152.

On the other hand, the metal mold 161, which applies a compressive force to the wooden piece 5 from below at the time of compression, is a cavity metal mold including a rectangular main body 162, and a depression 163 which is formed on one surface of the main body 162 and depressed downward. The metal mold 161 is provided with four discharge holes 164 which penetrate the main body 162 by extending downward in FIG. 10 from a bottom surface (contact surface) of the depression 163. The discharge holes 164 serve as discharge passages which discharge the water vapor (air) present between the wooden piece 5 and the depression 163 of the metal mold 161 to the outside at the time of compression.

In the second embodiment, the wooden piece 5 before the compression is in a flat-board-like shape. Therefore, the bottom surface of the protrusion 153 of the metal mold 151 first touches an upper flat surface of the wooden piece 5. Hence, the protrusion 153 does not need to have a penetrating hole. On the other hand, regions around four apexes of the substantially rectangular bottom surface of the depression 163 are not brought into contact with the wooden piece 5 until a later stage of the compression process. Without the discharge holes 164 in these regions, the pressure of the water vapor (air) confined between the wooden piece 5 and the metal mold 161 gradually increases along with the progress of the compression, so as to hamper the formation of the wooden piece 5 in conformity with the shape of the metal mold 161. In view of this, the discharge holes 164 are provided near the apexes of the substantially rectangular bottom surface of the depression 163.

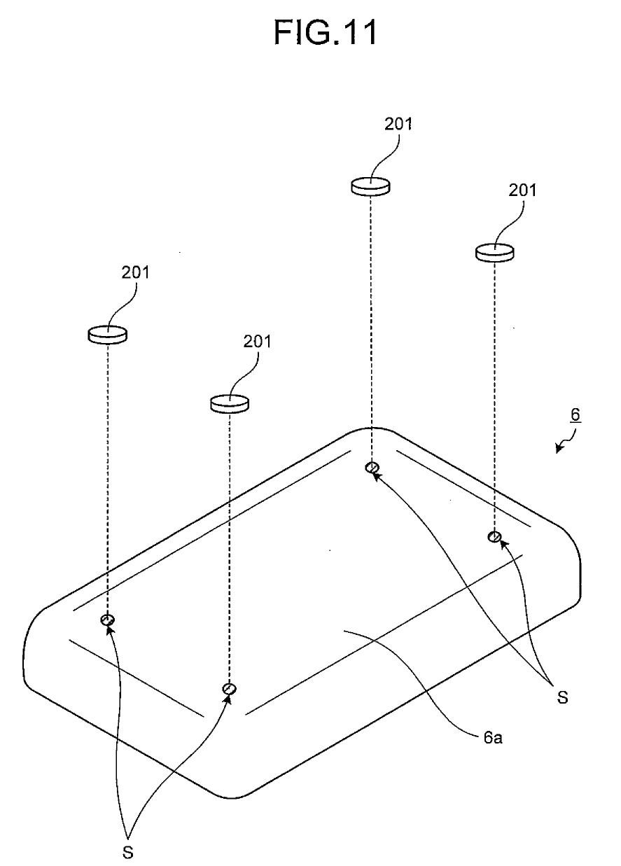

FIG. 11 shows a structure of a wooden piece after the compression by the metal molds 151 and 161 having the structures as described above. FIG. 11 shows a wooden piece 6 in a perspective view in which an upside and a downside are reversed from FIG. 10. The wooden piece 6, which is molded into a dish-like shape in the compression process, is deteriorated in portions near four apexes of a substantially rectangular main plate portion 6a which is a bottom surface of the dish-like shape, because these portions abut with the discharge holes 164 when brought into contact with the metal mold 161. Specifically, these four portions may bulge farther than the other portions of the main plate portion 6a, or may have different colors. Hence, in four deteriorated regions S shown in FIG. 11, antiskid pads 201 are respectively adhered. The antiskid pad 201 is larger than the deteriorated region S and is able to cover the deteriorated region S completely. Thus, problem in appearance caused by the deteriorated regions S can be solved, and further, an anti-slip function can be given to the bottom surface side of the dish-like wooden piece 6.

As described above, the metal mold for forming a wooden piece according to the second embodiment of the present invention is provided with the discharge holes (i.e., discharge passages) which penetrate the main body portion from the contact surface which is brought into contact with a wooden piece to be molded and are communicated with the outside. Therefore, the compression of a softened wooden piece can be performed without trouble.

In the metal mold for forming a wooden piece according to the second embodiment, an end opening of the discharge hole on the contact surface, which brought into contact with the wooden piece, is formed at such a position that the end opening can be brought into contact with at least a portion of a surface which is to be covered by a different member from the wooden piece after the compression. Therefore, even when the portions of the wooden piece opposing to the discharge holes are deteriorated due to compression, a compressed wooden product as a finished product has no marks of deteriorated regions. Thus, when the discharge holes are formed in positions which can be brought into contact with a portion of the wooden piece not utilized in the finished product, the compression of the wooden piece can be performed without trouble, and the appearance of the wooden piece in the finished product is not degraded.

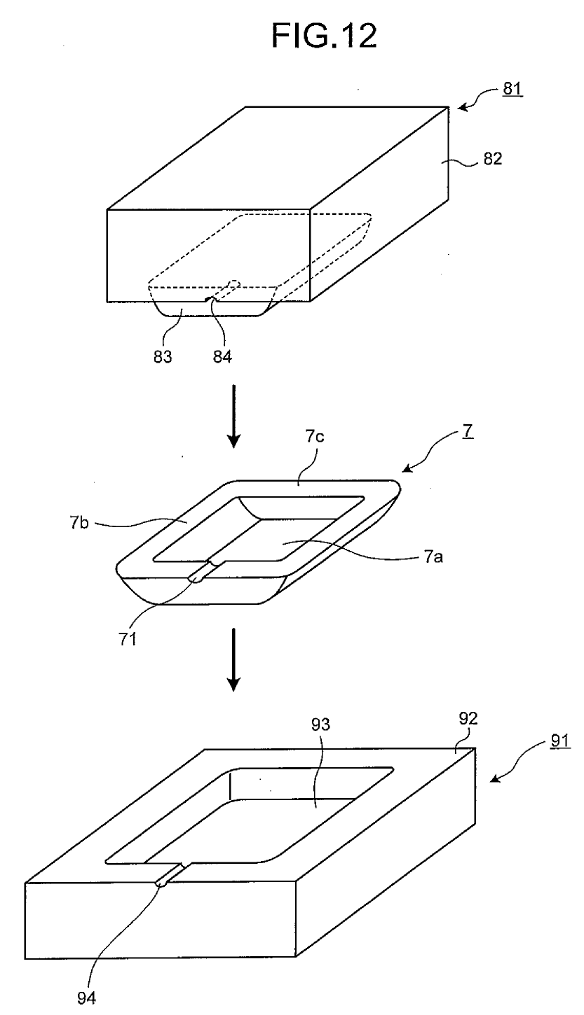

FIG. 12 shows a structure of a metal mold for forming a wooden piece according to a third embodiment of the present invention, and schematically shows a compression process of a wooden piece with the metal mold for forming a wooden piece. Metal molds 81 and 91, which are the metal mold for forming a wooden piece according to the third embodiment, are employed when sandwiching a dish-like wooden piece 7 (which includes a main plate portion 7a, and side plate portions 7b and 7c) cut out from the raw wood 10 and has a similar dish-like shape as the wooden piece 1, and performing the compression of the wooden piece 7.

The metal mold 81, which applies a compressive force to the wooden piece 7 from above during the compression process, is a core metal mold including a rectangular main body 82, and a protrusion 83 which bulges on the main body 82 and can be brought into contact with a curved surface (inner side surface) corresponding to a depressed portion of the wooden piece 7. The metal mold 81 has a discharge groove 84 which is formed to extend from a boundary between the main body 82 and the protrusion 83 to a side surface of the main body 82. The discharge groove 84 serves as a discharge passage which discharges the water vapor (air) present between the wooden piece 7 and the metal mold 81 to the outside at the time of compression.

On the other hand, the metal mold 91, which applies a compressive force to the wooden piece 7 from below during the compression process, is a cavity metal mold including a rectangular main body 92, and a depression 93 which is formed on one surface of the main body 92 and can be brought into contact with a curved surface (outer side surface) corresponding to the protruding portion of the wooden piece 7. The metal mold 91 is provided with a discharge groove 94 which is formed to extend from an upper edge of the depression 93 to a side surface of the main body 92. The discharge groove 94 serves as a discharge passage which discharges the water vapor (air) present between the wooden piece 7 and the metal mold 91 to the outside at the time of compression. The discharge groove 94 is formed at a position vertically opposing to the discharge groove 84 of the metal mold 81.

On an end surface of one of the side plate portions 7c of the wooden piece 7, which is subjected to the compression in the metal molds 81 and 91 having the structure as described above, a groove 71 is formed in a position facing the discharge groove 84 on the metal mold 81 at the time of compression. Thus, the third embodiment includes a groove-forming process in which the groove 71 is formed in the wooden piece 7 cut out from the raw wood 10. Thereafter, a softening process similar to that in the first embodiment is performed followed by the compression process. In the compression process, the wooden piece 7 is arranged so that the groove 71 is positioned below the discharge groove 84 of the metal mold 81 (see FIG. 12).

The compression process of the wooden piece 7 with the metal molds 81 and 91 is performed in a water vapor atmosphere similar to that employed in the softening process while the metal mold 81 is lowered. Water vapor present in the gap between the wooden piece 7 and the metal mold 81 is discharged through a gap formed by the discharge groove 84 on the metal mold 81 and the groove 71 on the wooden piece 71. Further, the water vapor present in the gap between the wooden piece 7 and the metal mold 91 is discharged through the discharge groove 94 to the outside.

As the metal mold 81 is lowered and the wooden piece 7 deforms, the groove 71 is gradually compressed to a smaller shape. Therefore, after the compression process, a portion around the groove 71 is sometimes deteriorated. For example, the portion is sometimes wrinkled, or a thickness of the portion around the groove 71 becomes uneven in comparison with other portions. To deal with the deterioration, it is sufficient if the groove 71 is formed in a portion removed through surface treatment such as cutting in the shaping process after the compression. Alternatively, the wooden piece may be configured so that an additional member covers a portion where the mark of the groove 71 is left. Thus, similarly to the first embodiment, the groove 71 is preferably formed in a portion which is not utilized in a finished product of the wooden piece 7 after the compression.

The metal mold for forming a wooden piece according to the third embodiment of the present invention as described above is configured with a pair of metal molds each having one of the discharge grooves (i.e., discharge passages) arranged so as to face with each other at least in a portion, whereby the compression of a softened wooden piece can be performed without trouble.

Further, at least a portion of the discharge groove is formed on each of the surfaces of metal molds opposing with each other and brought into contact when applying the compressive force to the wooden piece, and the groove is further formed on the end surface of the wooden piece to be molded at a position which opposes to the portion of the discharge groove of the metal mold when the wooden piece receives the compressive force. Therefore, plural discharge passages can be secured to discharge the water vapor present in the gap between the wooden piece and the metal mold, whereby the water vapor present between the metal mold and the wooden piece can be more securely discharged to the outside at the time of compression.

Still further, according to the third embodiment, the groove formed on the wooden piece is in a portion which is removed in the shaping process after the compression process, for example, and not utilized. Therefore, even when a portion around the groove is deteriorated due to compression, the mark of the groove is not left in the finished product after the shaping. Thus, according to the third embodiment, the appearance of the wooden piece in the finished product is not degraded.

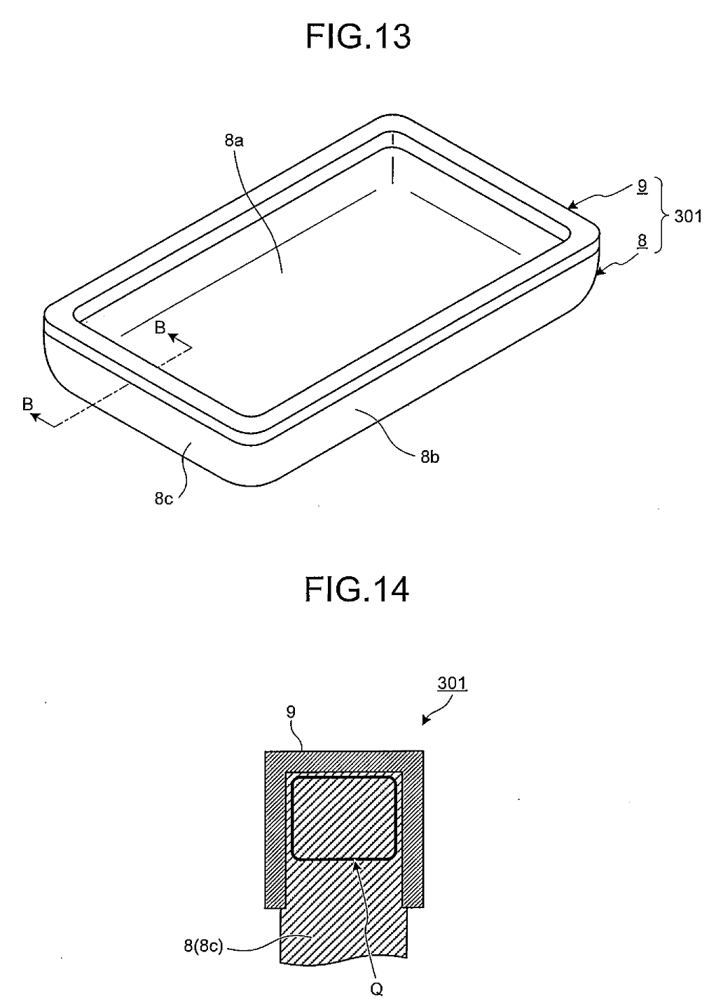

Instead of removing the groove 71 deteriorated through the compression process by cutting, it is possible to cover a region including a surrounding portion of the groove 71 with an additional member so that the deteriorated groove 71 cannot be seen from outside. FIG. 13 shows an example where the groove 71 is covered. FIG. 14 is a sectional view taken along line B-B of FIG. 13. In a compressed wood product 301 shown in FIGS. 13 and 14, a reinforcing member 9 is attached to a portion including the groove 71 around the end surface of the wooden piece 8 after the compression. The reinforcing member 9 is of metal (such as aluminum, stainless, titanium, and iron), or of hard synthetic resin (such as polyimide). The reinforcing member 9 is of a circular closed shape, and the vertical section thereof is U-shaped having a slightly narrower width than the thickness of the wooden piece 8 (see FIG. 14).

The reinforcing member 9 as described above has a function of reinforcing a portion around the end surface of the wooden piece 8, and of covering a deteriorated region Q around the groove 71 deteriorated by compression. Thus, even with the deterioration of the portion around the groove 71 by compression, a trace of the deteriorated portion cannot be found in the finished compressed wood product. Therefore, similarly as described above, an appearance of the wooden piece in the finished product is not degraded.

Though the exemplary embodiments of the present invention have been described above, the present invention is not limited to the three embodiments described above. Depending on conditions such as a kind of wooden piece cut out from a raw wood and a shape of a wooden piece before and after the compression, both the discharge hole of the first embodiment and the discharge groove of the third embodiment may be formed in appropriate positions as the discharge passages. Further, in some cases, formation of only one discharge passage (including the discharge hole and/or the discharge groove) in one metal mold of the pair of metal molds may be sufficient.

Further, the number of metal molds included in the metal mold for forming a wooden piece according to the present invention is not limited to two, as far as the metal molds can perform the compression of the wooden piece. Thus, the number of metal molds can be determined as appropriate according to the shape of the wooden piece and the like.

Thus, the present invention may include various embodiments not specifically described herein, and various modifications in design or the like can be performed within the scope of technical concepts identified by the appended claims.

The metal mold for forming a wooden piece according to the present invention is useful for compression of a wooden piece into a predetermined three-dimensional shape, and in particular, is suitable for compression of a wooden piece, which is applied as a jacket member for electronic devices such as digital cameras.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A metal mold for forming a wooden piece by applying a compressive force to the wooden piece, comprising:
a discharge passage for discharging air between the wooden piece and the metal mold to outside upon formation of the wooden piece.

2. The metal mold according to claim 1, wherein
the discharge passage includes a discharge hole that penetrates the metal mold from a contact surface to communicate with outside, the contact surface being brought into contact with the wooden piece when the compressive force is applied to the wooden piece.

3. The metal mold according to claim 2, wherein
the discharge hole has an end opening on the contact surface at a position with which at least a partial surface of the wooden piece to be removed after the compression can bring into contact.

4. The metal mold according to claim 2, wherein
the discharge hole has an end opening on the contact surface at a position with which at least a partial surface of the wooden piece can bring into contact, the partial surface being to be covered with a different member from the wooden piece after the compression.

5. The metal mold according to claim 2, further comprising
plural metal molds that, as a whole, are capable of sandwiching the wooden piece, wherein
the discharge hole is formed in at least one of the plural metal molds.

6. The metal mold according to claim 2, wherein
the wooden piece has a hole which penetrates the wooden piece in a thickness direction to communicate with the discharge hole when receiving a compressive force.

7. The metal mold according to claim 1, further comprising
plural metal molds that, as a whole, are capable of sandwiching the wooden piece, wherein
the discharge passage includes a discharge groove formed on a surface of at least one of the plural metal molds, the surface being brought into contact with one of the wooden piece and another of the plural metal molds when the compressive force is applied to the wooden piece.

8. The metal mold according to claim 7, wherein
at least a portion of the discharge groove is formed on surfaces of the metal molds, the surfaces facing with each other and being brought into mutual contact when the compressive force is applied to the wooden piece.

9. The metal mold according to claim 7, wherein
at least a portion of the discharge groove is formed in a portion with which at least a partial surface of the wooden piece to be removed after the compression can bring into contact.

10. The metal mold according to claim 7, wherein
at least a portion of the discharge groove is formed in a portion with which at least a partial surface of the wooden piece can bring into contact, the partial surface being to be covered with a different member from the wooden piece after the compression.

11. The metal mold according to claim 7, wherein
the wooden piece has a groove formed on an end surface which opposes to a portion of the discharge groove when the wooden piece receives the compressive force.
